(19) United States
(12) Patent Application Publication
(10) Pub. No.: US 2014/0071329 A1
(43) Pub. Date: Mar. 13, 2014

(54) RECONFIGURABLE OPTICAL DEVICE USING A TOTAL INTERNAL REFLECTION (TIR) OPTICAL SWITCH

(71) Applicant: Rambus Inc., Sunnyvale, CA (US)

(72) Inventor: Brian Edward Richardson, Los Gatos, CA (US)

(73) Assignee: Rambus Inc., Sunnyvale, CA (US)

(21) Appl. No.: 14/020,444

(22) Filed: Sep. 6, 2013

Related U.S. Application Data
(60) Provisional application No. 61/697,894, filed on Sep. 7, 2012.

(51) Int. Cl. G02B 17/00; H04N 5/225

(52) U.S. Cl. CPC G02B 17/006; H04N 5/2254
USPC 348/344

(57) ABSTRACT

An optical device having a total internal reflection (TIR) switch is able to switch to form two different optical imaging paths. Each optical imaging path has different optical characteristics that causes a detector to capture different imagery depending upon which optical imaging path is used. The TIR switch is switchable between a TIR state and a transmission state to control which optical imaging path is used by the device for imaging.

### BACKGROUND

Many mobile devices incorporate a camera for the capture of images or video. Examples include both smart phones and tablet computers. Typically, these cameras include only a single fixed focal length lens to reduce the total size, weight, and cost of the camera. Having only a fixed focal length lens, however, means that the camera is only capable of digital zoom, which necessarily reduces the quality of any captured images and limits the overall zoom range. More complex lens systems, such as are found in digital single lens reflex (SLR) cameras, are generally too large and expensive to incorporate into many mobile devices.

### BRIEF DESCRIPTION OF DRAWINGS

The devices described herein have advantages and features which will be more readily apparent from the following detailed description and the appended claims, when taken in conjunction with the accompanying drawings, in which:

FIG. 1 is a diagram of an example embodiment of an optical device capable of switching between two different optical imaging paths.

FIG. 2A is a block diagram of an example embodiment of an optical device configured to switch between two optical paths with different front portions.

FIG. 2B is a block diagram of an example embodiment of an optical device configured to switch between two optical paths with different back portions.

FIG. 2C is a block diagram of an example embodiment of an optical device configured to switch between two optical paths with different intermediate portions.

FIG. 2D is a block diagram of an example embodiment of an optical device capable of switching between more than two optical paths with different portions.

FIG. 3 is a perspective view of an example embodiment of an optical device capable of switching between two optical imaging paths with different focal lengths.

FIGS. 4A and 4B are side views illustrating operation of the optical device of FIG. 3.

FIG. 5 is a side view of an example embodiment of an optical device where the two optical imaging paths are oriented to receive light from different axial directions.

FIG. 6 is a side view of an example embodiment of an optical device where the front apertures of the two optical imaging paths are spatially offset from one another.

FIG. 7 is a side view of an example embodiment of an optical device capable of switching between three different optical imaging paths.

FIG. 8 is a block diagram of an example embodiment of a mobile computing device incorporating an optical device capable of switching between two different lenses.

The figures depict embodiments of the optical device for purposes of illustration only. One skilled in the art will readily recognize from the following discussion that alternative embodiments of the structures and methods illustrated herein may be employed without departing from the principles described herein.

### DETAILED DESCRIPTION

An optical device having a total internal reflection (TIR) switch is able to switch between two different optical imaging paths. Each optical imaging path has different optical characteristics and/or different sensor planes that cause a detector (or detector array) to capture different imagery depending upon which optical imaging path is used. The TIR switch is switchable between a TIR state and a transmission state to control which optical imaging path is used by the device for imaging.

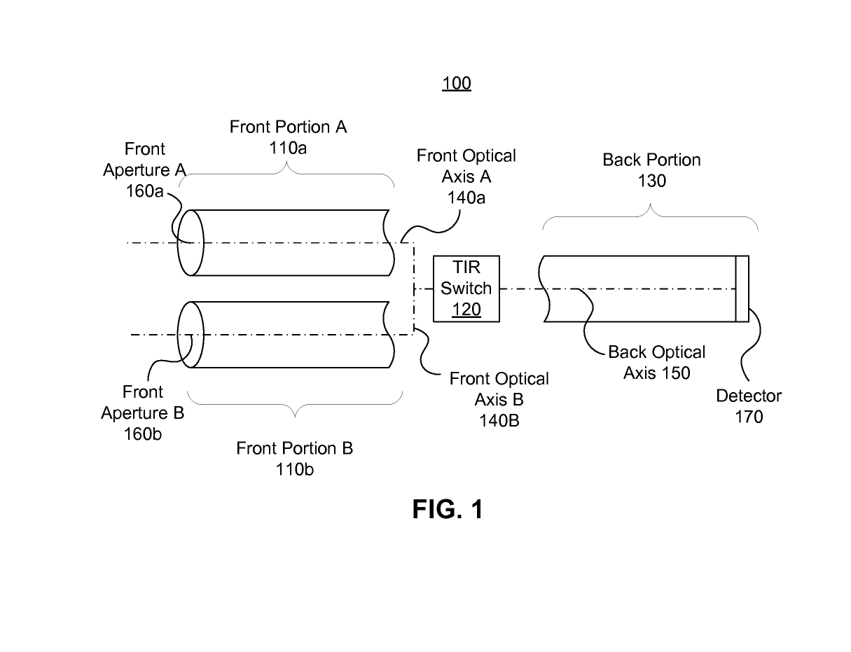

FIG. 1 is a diagram of an example embodiment of an optical device 100 capable of switching between two different optical imaging paths. The optical device 100 includes two different front portions: front portion A 110a and front portion B 110b. Each front portion 110 is configured to receive incident light through its respective front aperture 160. The optical device 100 also include a common back portion 130. Front portion A 110a and common back portion 130 form one optical imaging path A, and front portion B 110b and common back portion 130 from another optical imaging path B. The two optical imaging paths A and B have different imaging characteristics, resulting in different images captured by the detector 170 depending on which front portion 110 is in use.

The front portions 110 are switchably optically coupled to the back portion 130 depending on the state of TIR switch 120. The TIR switch 120 controls the transmission of light from the front portions 110 to the back portion 130. Back portion 130 images light received from the front portions 110 onto a detector 170. The optical device 100 may also be coupled to electronics (not shown), for example a computer or other processing device, in order to process or store images captured by the detector 170.

The TIR switch 120 is configured to switch an interface between two different states: a “TIR” state and a “transmission” state. In the TIR state, light from the front optical axes experiences total internal reflection (TIR) at the interface within the TIR switch. In the transmission state, the light is transmitted through the interface rather than experiencing TIR. In this way, the TIR switch 120 can switch light coupled to the back optical axis between two different front optical axes, with the unselected front axis having its light directed away from detector 170. The TIR and transmission states of the TIR switch 120 may also be referred to, interchangeably, as the first and second states of the TIR switch 120.

In FIG. 1, the TIR switch 120 switches between front portion A 110a and front portion B 110b. When the TIR switch 120 is in the transmission state, front portion A 110a is coupled to the back portion 130. In this state, incident light enters front portion A 110a through front aperture 160a, travels through front portion A 110a, through the TIR switch 120, and through the back portion 130 to detector 170. This forms optical imaging path A, with an optical axis formed by front optical axis A 140a and back optical axis 150. When the TIR switch 120 is in the transmission state, incident light entering front portion B 110b travels through the TIR switch 120 in a direction that does not allow the light to reach detector 170.

When the TIR switch 120 is in the TIR state, front portion B 110b is coupled to the back portion 130. Incident light enters front portion B 110b through the front aperture 160b, travels through front portion B 110b, experiences TIR at the TIR switch 120, and travels through the back portion 130 to detector 170. This forms optical imaging path B, with an optical axis formed by front optical axis B 140b and back optical axis 150. When the TIR switch 120 is in the TIR state, incident light entering front portion A 110a experiences TIR at the TIR switch 120 and is reflected in a direction that does not allow the light to reach detector 170.

The implementation of the TIR switch 120 may vary. In one embodiment, the TIR switch includes an interface between two surfaces (not shown) of two different structures, each structure having a substantially similar refractive index to the other structure, each structure having a refractive index greater than one. In the TIR state, there is a gap at the interface between the two surfaces, where the gap contains a material with a lower refractive index than the refractive index of the structures. For example, the gap may be filled with air. The difference in refractive index is sufficiently large for the given incidence angles of the front optical axes at the interface that light passing through the structures primarily experiences total internal reflection off one of the surfaces. In one embodiment, the gap is sufficiently large to effect TIR if the gap is at least as large as an operating wavelength of the optical device 100. In the transmission state, the gap between the two structures is substantially closed or filled with a material of higher refractive index, so that light primarily experiences transmission through the interface.

This may be accomplished, for example, by physically moving one or both of the structures to make the interface gap smaller than the operating wavelength of the optical device 100. The mechanism changing the size of the gap may vary. For example, the size of the gap between the surfaces may be controlled using a mechanical actuator such as an electroactive polymer or a piezoelectric material.

Alternatively, the gap may be created and closed by filling the interface gap with a material having a similar refractive index to that of the structures. For example, if the surfaces are made of glass, another piece of glass may be introduced or removed from the gap to switch the state of the TIR switch 120. The material may also, for example, be a liquid such as water.

In another example, the two surfaces may be separated by a variable refractive index (VRI) material, such as a liquid crystal material. In the transmission state, the refractive index of the VRI material may be set to be a value close enough to that of the two structures to allow transmission of light between the surfaces. In the TIR state, the refractive index of the VRI material may be set to a value sufficiently lower than that of the two structures so as to create total internal reflection at the interface.

The front portions 110a and 110b are different so that images captured by the detector 170 will differ depending upon whether the optical imaging path A or B is used. The two optical imaging paths A and B may differ with respect to focal length, field of view, F-number, aperture size and/or aperture location. They may also use different filters, for example wavelength filters, neutral density filters or polarization filters. Each optical imaging path may also have its front optical axis oriented in a different axial direction so that each imaging path is “looking” in a different axial direction.

Each optical imaging path may use different combination of lenses, mirrors and/or filters to achieve particular imaging characteristics. For example, front portions may incorporate fixed focal length lenses of selected fields of view, including normal lenses, telephoto lenses, wide angle lenses, and non-rectilinear (e.g., fisheye) lenses, or zoom lenses having a field of view range within one or more of the above classifications. In one design, each front portion uses a different one of these lenses. Thus, optical imaging path A might provide a base capability using a wide angle lens while optical imaging path B uses a telephoto lens to provide optical telephoto capability.

For filters, each optical imaging path may use filters of varying types. Different types of filters include dichroic filters, monochromatic filters, infrared (IR) filters, ultraviolet (UV) filters, neutral density filters, longpass filters, bandpass filters, shortpass filters, and guided-mode resonance filters. The filters may not be permanent filters. They could be removable or interchangeable, either manually, remotely or automatically.

The back portion 130 includes a detector (or detector array) 170 for capturing the optical image. Examples of detector 170 include CCD arrays and CMOS active pixel arrays. The back portion 130 may also implement other portions of the overall optical imaging path, including the materials and structures described above (e.g, lenses, mirror, filters, etc.).

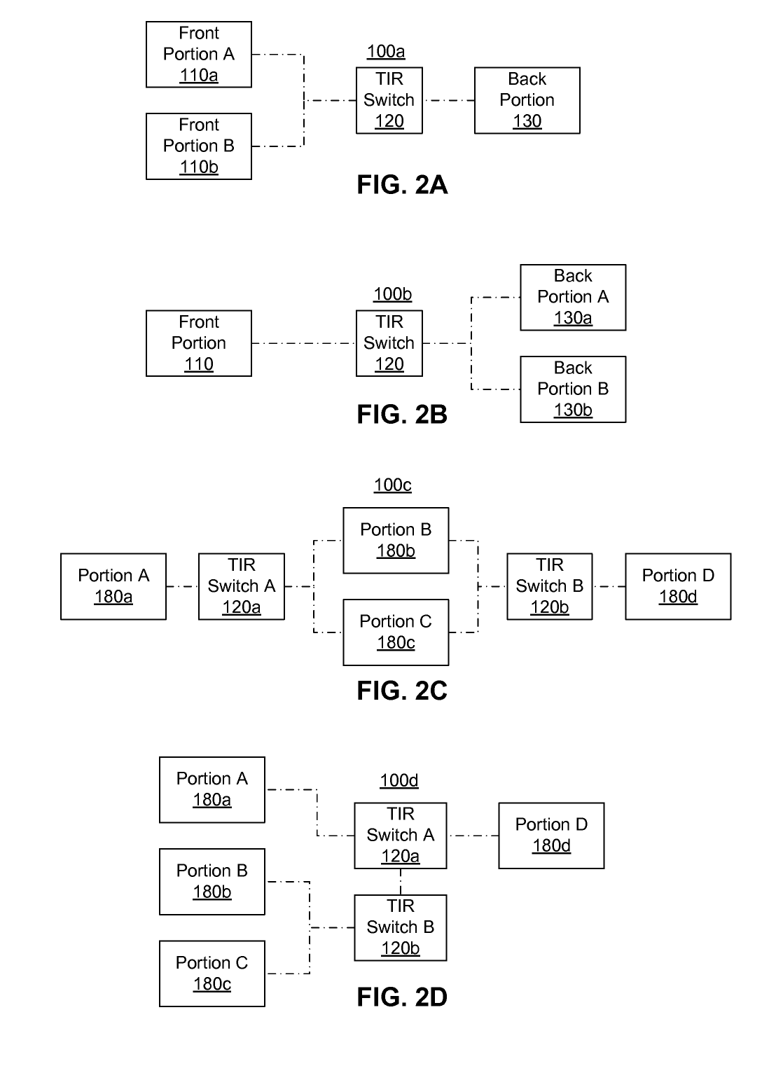

FIG. 2A is a block diagram representation of the optical device shown in FIG. 1. This optical device uses a common back portion 130 and switches between two possible front portions 110a-b. FIGS. 2B-2D show alternate embodiments.

FIG. 2B is a block diagram of an example embodiment of an optical device 100b configured to switch between two different back portions 130. When the TIR switch 120 is in one state, common front portion 110 and back portion A 130a form one optical imaging path A. When the TIR switch 120 is in the other state, common front portion 110 and back portion B 130b form a different optical imaging path B.

The two optical imaging paths A and B (and their corresponding back portions 130a and 130b) differ with respect to their imaging characteristics. Many of the variations described above are also applicable in this configuration.

Back portions 130 may also differ with respect to the detector and subsequent electronics. Each back portion 130 includes its own detector (not shown). The back portions 130 may each have the same detector or a different detector. The back portions 130 may also have the same detectors, but may operate the detectors differently in order to capture light differently. For example, a detector in back portion A 130a may be powered or otherwise configured so as to capture light in a first wavelength range, whereas a detector in back portion B 130b may be powered or otherwise configured so as to capture light in a second wavelength range. The detector and corresponding electronics may be powered down to save energy when a specific back portion is not in use. The back portions may have detectors that differ in sensor area, number of pixels, size of pixels, wavelength sensitivity or filtering, optical sensitivity, noise characteristics, dynamic range and/or speed of operation.

FIG. 2C is a block diagram of an example embodiment of an optical device 100c configured to switch between two optical paths with different intermediate portions. The optical device 100c may include more than one optical switch 120a and 120b.

In one implementation, optical device 100c includes portion A 180a coupled to TIR switch A 120a. TIR switch A 120a switchably optically couples portion A 180a to one of intermediate portions B 180b and C 180c. Intermediate portions B 180b and C 180c are also switchably optically coupled to portion D 180d by TIR switch B 120b. One optical imaging path is formed by portion A 180a, portion B 180b and portion D 180d. A different optical imaging path is formed by portion A 180a, portion C 180c and portion D 180d. TIR switches 120 are set to the appropriate states to form the desired optical imaging path. Note that this configuration can also include states where no optical imaging path is formed, for example when TIR switch A 120a couples Portion A 180a to Portion B 180b but TIR switch B 120b couples Portion C 180c to Portion D 180d. Note also that switches 120a and 120b need not both be TIR switches. One might be a TIR switch while the other is a different type of switch.

FIG. 2D is a block diagram of an example embodiment of an optical device 100d capable of switching between more than two optical paths with different portions. In the example of FIG. 2D, optical device 100d includes two TIR switches 120 for switching between three different portions. Portion B 180b and portion C 180c are switchably optically coupled by TIR switch B 120b to TIR switch A 120a. Portion A 180a and TIR switch B 120b are switchably optically coupled by TIR switch A 120a to portion D 180d.

In one configuration, TIR switch A 120a couples portion A 180a to portion D 180d, forming a first optical imaging path. In a second configuration, TIR switches A 120a and B 120b couple portion B 180b to portion D 180d, forming a second optical imaging path. In a third configuration, TIR switches A 120a and B 120b couple portion C 180c to portion D 180d, forming a third optical imaging path.

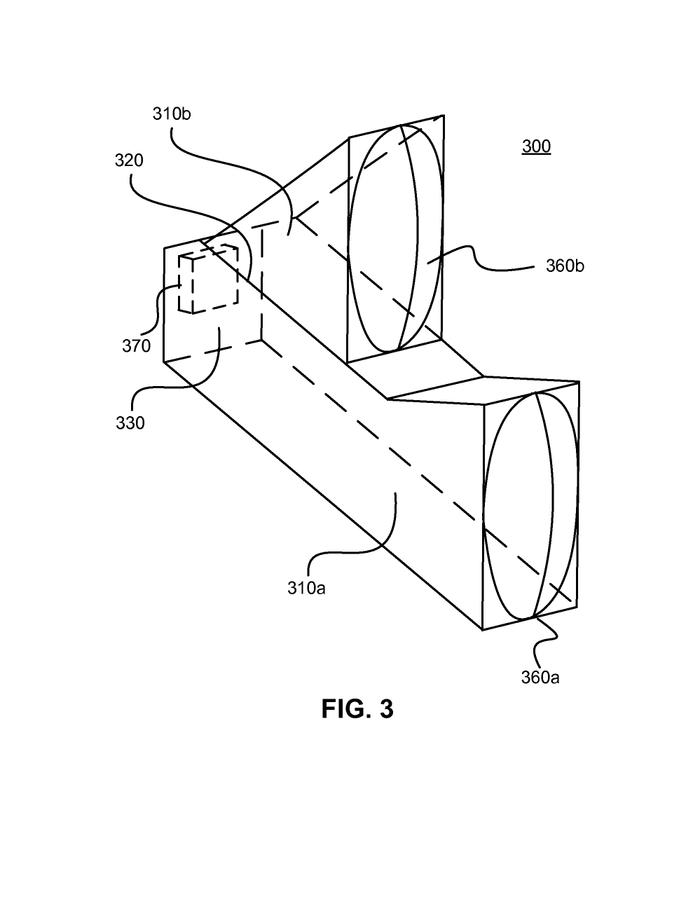

FIG. 3 is a perspective view of an example embodiment of an optical device 300 capable of switching between two optical imaging paths with different focal lengths. Optical device 300 includes a TIR optical switch 320 that uses two surfaces, each surface belonging to a different structure of the optical device 300. The two surfaces are located in close proximity to one another to allow the switch to be “closed” to defeat TIR. The optical device 300 also includes two different optical imaging paths of different focal lengths. One optical imaging path A is formed by a front portion A 310a and a common back portion 330. The front portion A 310a includes an aperture 360a with a lens (typically a system of lenses, one is shown for simplicity) supporting a first focal length. The other optical imaging path B is formed by a front portion B 310b and the common back portion 330. The second front portion B 310b includes an aperture 360b with a lens (typically a system of lenses, one is shown for simplicity) supporting a second focal length different from the first focal length.

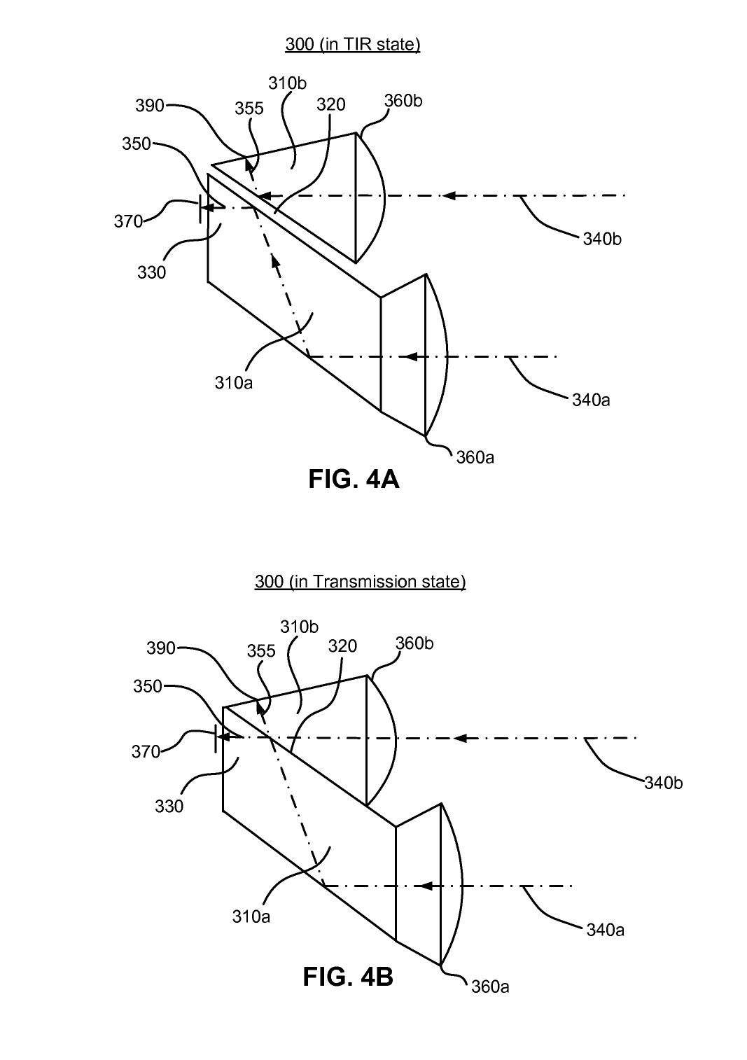

FIGS. 4A and 4B are side views of optical device 300. In FIG. 4A, the TIR switch 320 is in a TIR state, and in FIG. 4B, the TIR switch 320 is in a transmission state. FIGS. 4A and 4B also show the optical axes 340a, 340b, and 350 of the optical imaging paths.

In FIG. 4A, the TIR optical switch 320 is in a TIR state. In the TIR state, light traveling along front optical axis A 340a enters the optical device 300 through aperture A 360a. This light experiences total internal reflection twice, once at a bottom surface of structure 310a, and again at a surface of the open TIR optical switch 320, and is reflected along back optical axis 350 to detector 370. Optical imaging path A includes front optical axis A 340a and back optical axis 350. That is, in the TIR state, the TIR optical switch 320 couples the front portion A 310a to common back portion 330, forming optical imaging path A. Meanwhile, light traveling along front optical axis B 340b is also reflected via total internal reflection by a surface of open TIR switch 320. This reflected light travels along optical axis 355 where it is absorbed by an optical dump 390.

FIG. 4B is a side view of optical device 300, with the TIR optical switch 320 in a transmission state. In the transmission state, light traveling along front optical axis B 340b enters the optical device 300 through aperture B 360b. This light is transmitted through the closed TIR optical switch 320 and along back optical axis 350 to detector 370. Optical imaging path B includes front optical axis B 340b and back optical axis 350. That is, in the transmission state, the TIR optical switch 320 couples the front portion B 310b to common back portion 330, forming optical imaging path B. Light entering front portion A 310a travels along optical axis A 340a, reflects off the bottom surface of structure 310a, passes through the closed TIR switch 320, and then along optical axis 355 to the optical dump 390.

In one variation, the locations of the detector 370 and optical dump 390 are reversed. In that case, front portion B 310b and optical imaging path B will be the active components when the TIR switch 320 is in the TIR state. Front portion A 310a and optical imaging path A will be the active components when the TIR switch 320 is in the transmission state.

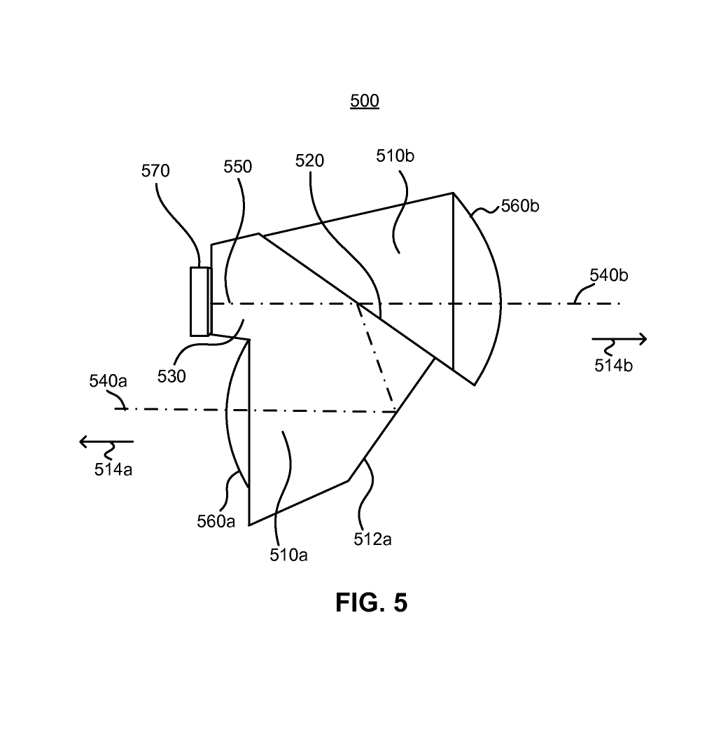

FIG. 5 is a side view of an example embodiment of an optical device 500 where the front portions are oriented in different axial directions to receive light. Front portion A 510a and common back portion 530 form one optical imaging path A, while front portion B 510b and common back portion 530 form the other optical imaging path B. In optical device 500, aperture A 560a of front portion A is oriented in a first axial direction 514a that is opposite (e.g., 180 degrees different than) a second axial direction of orientation 514b of aperture B 560b of front portion B. In other optical devices (not shown), the difference between the axial directions any two front portions are oriented may vary between 0 and 180 degrees along any axis of orientation (e.g., x, y, and z). Front portion A may also include structures or materials to redirect the first optical axis 540a towards the TIR switch 120. For example, the first front portion 510a may include a mirrored surface 512a. This configuration may be useful, for example, in a mobile phone or tablet device where one optical imaging path is looking forward and the other optical imaging path is looking backwards.

Other than having their apertures 560 oriented in different axial directions, the front portions of optical device 500 may be similar or identical in their imaging characteristics. For example, the apertures 560a and 560b of the front portions of optical device 800 may contain lenses of the same focal length. Alternatively, the front portions may also vary with respect to their imaging characteristics in addition to being oriented in different directions.

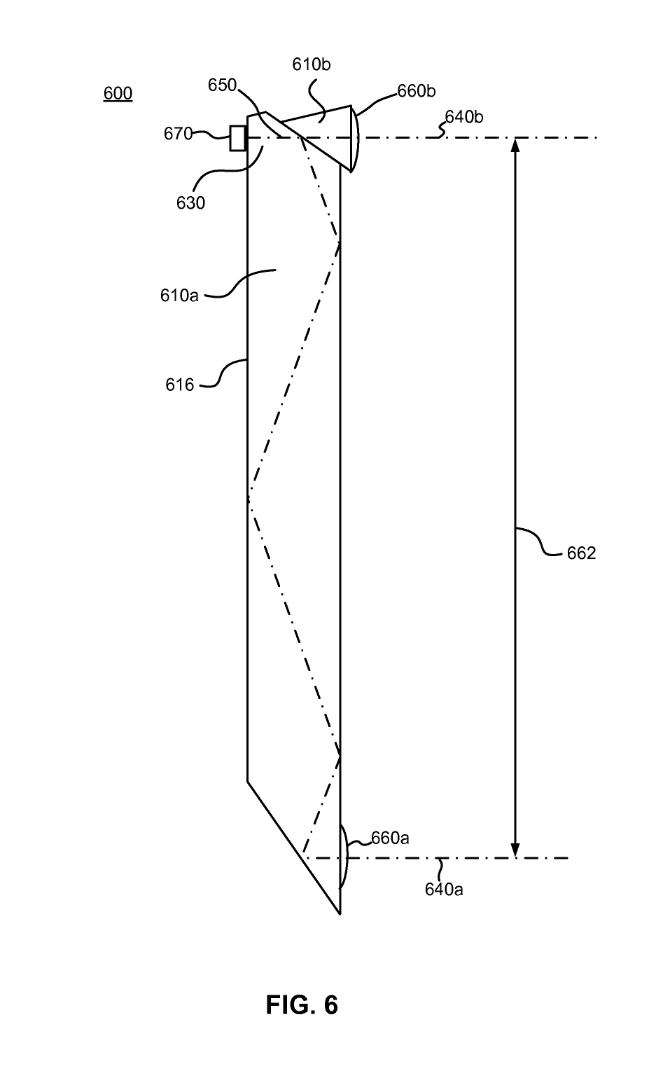

FIG. 6 is a side view of an example embodiment of an optical device 600 where the front apertures of the two optical imaging paths are spatially offset from one another by a significant baseline distance. Front portion A 610a and common back portion 630 form one optical imaging path A with multiple reflections, while front portion B 610b and common back portion 630 form the other optical imaging path B. In optical device 600, front aperture A 660a is spatially offset from front aperture B 660b by a significant baseline distance 662. The front portions may be spatially offset by using an optical waveguide 616. Other than having their apertures 660 offset, the front portions of optical device 600 may be similar or identical in their imaging characteristics. For example, the apertures 660a and 660b of the front portions of optical device 600 may function with similar focal lengths. Alternatively, the front portions may also vary with respect to their imaging characteristics in addition to being spatially offset.

An optical device 600 having apertures 660 spatially offset may be used, for example, in stereo imaging applications. Optical imaging paths A and B may capture right and left eye images, respectively. The optical device 600 may be operated so as to alternate the state of the TIR switch 620 in order to capture stereo images from the optical imaging paths.

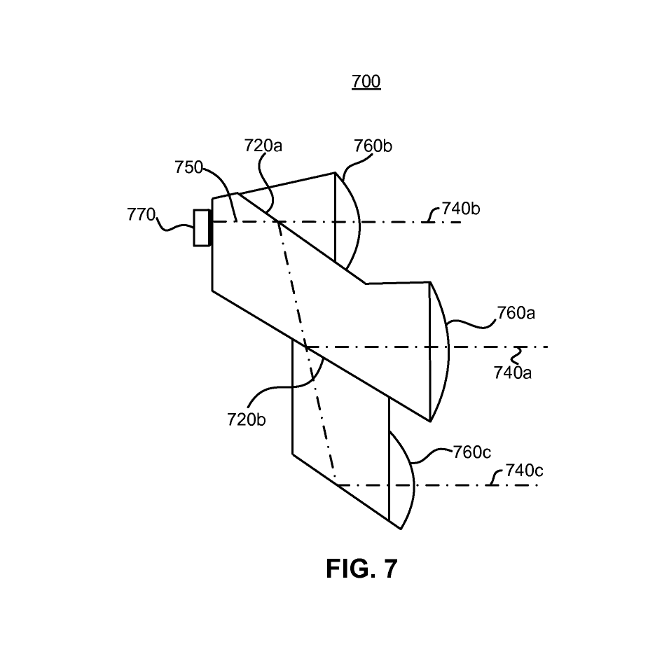

FIG. 7 is a side view of an example embodiment of an optical device capable of switching between three different optical imaging paths. Optical device 700 includes two TIR switches 720a and 720b for switching between the three different front portions having different apertures A 760a, B 760b, and C 760c. Portion B including aperture 760b and TIR switch 720b are switchably optically coupled to TIR switch 720a. Portion A including aperture 760a and portion C including aperture 760c are switchably optically coupled to TIR switch 720b.

When TIR switch 720a is in the transmission state, optical axis 740b is coupled to the back optical axis 750 and detector 770, forming an optical imaging path B. When TIR switch 720a is in the TIR state and TIR switch 720b is also in the TIR state, optical axis 740a is coupled to the detector 770, forming an optical imaging path A. When TIR switch 720a is in the TIR state and TIR switch 720b is in the transmission state, optical axis 740c is coupled to the detector 770, forming an optical imaging path C.

In the above example embodiments, the optical device has been described as switching between optical imaging paths using a TIR optical switch. In other embodiments, other types of switches may be used to switch between optical imaging paths. For example, electrochromism may be used to create a switch in place of TIR to switch between optical imaging paths. An electrochromic switch is configured to transition between at least two states, a transmission state and a reflection state. As with the TIR switch, in a transmission state, the electrochromism switch transmits light through. In the reflective state, the electrochromic switch reflects light.

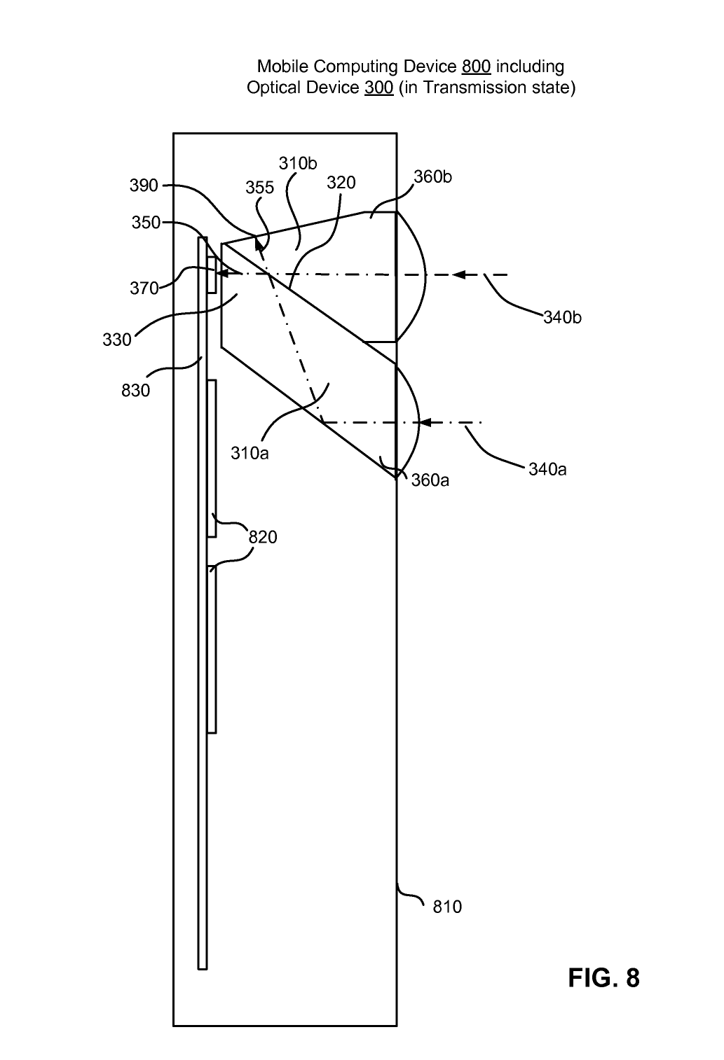

FIG. 8 is a block diagram of an example embodiment of a mobile computing device 800 incorporating an optical device 300 capable of switching between two different lenses. The optical devices described above can be used in many applications. One example is cameras incorporated in mobile computing devices, such as mobile phones and tablet computers. In one implementation, the mobile computing device 800 includes a housing 810 and one or more processors 820 located internal to the housing 810. The mobile computing device 800 also includes a multi-lens camera, using the principles described above to switch between the different lenses. For example, the multi-lens camera may include an optical device such as optical device 300 as described above. The detector 370 of the optical device 300 may be attached to the processors 820 using a printed circuit board 830. The optical device 300 may also be located inside the housing 810 as illustrated, or alternatively may be located external to the housing 810. The illustrated configuration can be used to implement a built-in camera with two (or more) lenses of different focal lengths. In this way, the zoom range of the camera can be extended. Rather than relying on a single lens with a limited digital zoom range (i.e., zoom implemented by digitally processing the captured data), two lenses can be used. Each lens has its own digital zoom range. If the ranges are overlapping, then the overall range will extend from the lowest zoom of the one lens to the highest zoom of the other lens.

As another example, the configuration of FIG. 5 can be used to provide both forward looking and backward looking fields of view. If more lenses are used (or if the two lenses have 180 degree or greater fields of view), then a 360 degree panoramic field of view can be achieved. As a final example, the configuration of FIG. 6 can be used to capture images from different points of view, for example stereo images.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A reconfigurable optical device comprising:
a first front portion of a first optical imaging path;
a second front portion of a second optical imaging path, the first and second optical imaging paths having different imaging characteristics;
a back portion that is common to both the first and second optical imaging paths; and
a total internal reflection (TIR) optical switch that is switchable between a TIR state and a transmission state, the TIR optical switch positioned to (a) optically couple the first front portion with the back portion to form the first optical imaging path when in the TIR state, and (b) optically couple the second front portion with the back portion to form the second optical imaging path when in the transmission state.

2. The device of claim 1 wherein the TIR optical switch comprises a first surface and a second surface, and wherein in the TIR state a separation of the first and second surface is sufficiently large to produce total internal reflection at least at the first surface and in the transmission state a separation of the first and second surfaces is sufficiently small to produce transmission through the first and second surfaces.

3. The device of claim 2 wherein the TIR optical switch further comprises a mechanical actuator that changes the separation between the first and second surfaces, the mechanical actuator using at least one actuation element selected from the group consisting of an electro active polymer and a piezoelectric material.

4. The device of claim 1 wherein the TIR optical switch comprises a first surface and a second surface separated by a variable refractive index (VRI) material, wherein in the TIR state the VRI material is switched to have a refractive index that is sufficiently low to produce total internal reflection at the first surface and in the transmission state the VRI material is switched to have a refractive index that is sufficiently high to produce transmission through the first and second surfaces.

5. The device of claim 1 wherein the first and second optical imaging paths have different focal lengths.

6. The device of claim 1 wherein the first and second optical imaging paths have different fields of view.

7. The device of claim 1 wherein the first and second optical imaging paths have different aperture sizes.

8. The device of claim 1 wherein the first and second optical imaging paths have different wavelength filtering.

9. The device of claim 1 wherein the first and second optical imaging paths have different polarization filtering.

10. The device of claim 1 wherein the first and second front portions each comprises at least one lens.

11. The device of claim 10 wherein the first front portion, when coupled with the back portion, comprises a lens selected from the group consisting of a telephoto lens, a normal lens, a wide angle lens, and a fisheye lens, and the second front portion, when coupled with the back portion, comprises a different lens from said group.

12. The device of claim 1 wherein the first and second front portions are oriented to receive light from substantially a same axial direction.

13. The device of claim 1 wherein the first and second front portions are oriented to receive light from substantially different axial directions.

14. The device of claim 13 wherein the first and second front portions are oriented to receive light from substantially opposite axial directions.

15. The device of claim 1 wherein one of the front portions comprises a front aperture and an optical waveguide located between the front aperture and the TIR switch.

16. The device of claim 1 further comprising:
a third front portion of a third optical imaging path, the first, second, and third optical imaging paths have different imaging characteristics; and
a second total internal reflection (TIR) optical switch that is switchable between a TIR state and a transmission state;
wherein the first and second TIR optical switches are positioned to switchably optically couple one of the first, second and third front portions with the back portion, thus forming one of the first, second and third optical imaging paths, respectively.

17. A reconfigurable optical device comprising:
a first optical subsystem;
a second optical subsystem;
a common optical subsystem; and
a TIR optical switch that is switchable between a TIR state and a transmission state, the TIR optical switch positioned to (a) optically couple the first optical subsystem with the common optical subsystem to form a first optical imaging path when in the TIR state, and (b) optically couple the second optical subsystem with the common optical subsystem to form a second optical imaging path when in the transmission state; wherein the first and second optical imaging paths have different imaging characteristics.

18. The reconfigurable optical device of claim 17 wherein the common optical subsystem is a common front portion, the first optical subsystem is a back portion of the first optical imaging path, and the second optical subsystem is a back portion of the second optical imaging path.

19. The reconfigurable optical device of claim 17 wherein the first and second optical imaging paths have detectors with different numbers of pixels.

20. The reconfigurable optical device of claim 17 wherein the first and second optical imaging paths have detectors with different pixel sizes.

21. The reconfigurable optical device of claim 17 wherein the first and second optical imaging paths have detectors of different optical sensitivity.

22. A mobile computing device comprising:
a housing;
a processor located internal to the housing; and
a multi-lens camera comprising:
a first front portion of a first optical imaging path, the first front portion including a first lens assembly coupled to the housing;
a second front portion of a second optical imaging path, the second front portion including a second lens assembly coupled to the housing, the first and second optical imaging paths having different imaging characteristics;
a back portion that is common to both the first and second optical imaging paths, the back portion located internal to the housing and including a detector array; and
a total internal reflection (TIR) optical switch that is switchable between a TIR state and a transmission state, the TIR optical switch positioned to (a) optically couple the first front portion with the back portion to form the first optical imaging path when in the TIR state, and (b) optically couple the second front portion with the back portion to form the second optical imaging path when in the transmission state.

23. The mobile computing device of claim 22 wherein the mobile computing device is a mobile phone.

24. The mobile computing device of claim 22 wherein the mobile computing device is a portable computer.

25. The mobile computing device of claim 22 wherein the mobile computing device is a tablet computer.

26. The mobile computing device of claim 22 wherein the first and second optical imaging paths have different focal lengths and the processor is configured to provide digital zoom to both optical imaging paths.

27. The mobile computing device of claim 22 wherein the first and second optical imaging paths are oriented to receive light from substantially a same axial direction.

28. The mobile computing device of claim 22 wherein the first and second optical imaging paths are oriented to receive light from substantially opposite axial directions.

29. The mobile computing device of claim 22 wherein the first and second optical imaging paths are oriented to receive light from substantially a same axial direction but have spatially separated front apertures.

30. The mobile computing device of claim 29 wherein the first and second optical imaging paths are oriented to capture stereo images.

31. The mobile computing device of claim 22 wherein the multi-lens camera is capable of capturing a panoramic image without moving the camera position.
